(19) United States
(12) Patent Application Publication
(10) Pub. No.: US 2013/0169540 A1
(43) Pub. Date: Jul. 4, 2013

(54) Moving virtual keyboard

(71) Applicant: Huy Hai Dinh, Pittsburgh, PA (US)

(72) Inventor: Huy Hai Dinh, Pittsburgh, PA (US)

(21) Appl. No.: 13/343,002

(22) Filed: Jan. 4, 2012

(51) Int. Cl. G06F 3/02

(52) U.S. Cl. 345/168

(57) ABSTRACT

A method for identifying user inputs is invented. A transparent virtual keyboard moves like a pointer when a user drags one finger on the lower right corner of a touch screen. The user moves the virtual keyboard so that an intended symbol moves into the text prompt of a textbox. Then, the user either moves the virtual keyboard to opposite direction or taps the lower left corner of the touch screen to enter the symbol into the textbox. The transparent virtual keyboard enables the user to interact with the current application.

### FIELD OF THE INVENTION

The invention relates to a virtual keyboard for touch screen devices.

### BACKGROUND

Present day, mobile devices are usually use small screens. These devices usually use virtual keyboards to receive inputs from users. These virtual keyboards usually have fewer rows than regular ones and include a row for suggested words. A user enters a symbol to a textbox by either tapping or touching the key with the symbol. Due to their small screen sizes, whenever a user need to use keyboard, the virtual keyboard covers most of the screen and the user can only see the textbox that they are typing. When a user is typing, the user can only see either keyboard or the word that the user is typing at a time. If the user touches wrong keys, the user will not realize the typing errors until the user looks at the word in the textbox. Keys and suggested words of virtual keyboard are too small that it is easy to touch wrong keys.

### SUMMARY OF THE INVENTION

The present invention overcomes above drawbacks. The invention make a virtual keyboard moves like a pointer when a user drags one finger on the right lower corner of a touch screen. The invention makes the virtual keyboard transparent so that the user can see the current application interface and the virtual keyboard at the same time. The virtual keyboard will be only as big as the user needed to see clearly every symbol on the virtual keyboard. The user moves the keyboard so that an intended symbol moves into the text prompt. Then, the user either changes the moving direction of the virtual keyboard or taps the lower left corner to enter the symbol. The user change symbols on the virtual keyboard by tapping the lower right corner. Users can touch any areas of the screen except two lower corner areas to interact with the current application.

### BRIEF DESCRIPTION OF THE DRAWINGS

Having thus described the invention in general terms, references will now be made to the accompanying drawings, which are not necessarily drawn to scale, wherein keys representing letters in the keyboard are laid out according to the QWERTY layout, and wherein:

FIG. 1 shows the screen without the virtual keyboard.

FIG. 2 shows the screen when a user first touches the textbox.

FIG. 3 shows how symbols on the virtual keyboard change, when user taps the “ABC” on the lower right corner.

FIG. 4 shows how symbols on the virtual keyboard change, when user taps the “123@” on the lower right corner.

FIG. 5 shows the screens when user moves the symbol “1” into the position of the text prompt.

FIG. 6 shows the screen when user moves the keyboard to almost opposite direction compare to the direction when user moves symbol “1” to the text prompt or when user tap the left lower corner of the screen.

FIG. 7 shows the screens when user moves the symbol “hello” into the position of the text prompt.

FIG. 8 shows the screen when user moves the keyboard to almost opposite direction compare to the direction when user move symbol “hello” to the text prompt or when user tap the left lower corner of the screen.

### DETAILED DESCRIPTION OF THE INVENTION

The present invention now will be described more fully hereinafter with reference to the accompanying drawings, in which one example of the embodiments of the invention are shown.

Indeed, the invention may be embodied in many different forms and should not be construed as limited to the embodiment set forth herein; rather, the embodiment is provided by way of example so that this disclosure will satisfy applicable legal requirements. The invention only shows the graphical interface of a mobile device. The mobile device contains other components to make it works properly. Those skilled in the art understand of these components. Therefore, the invention will not describe how these components work.

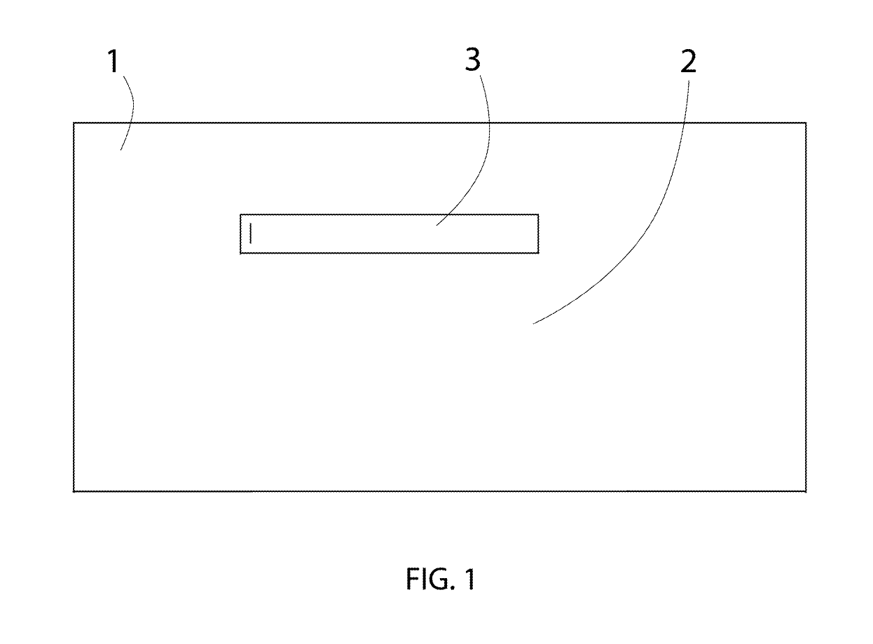

FIG. 1 illustrates a touch screen in accordance with a preferred embodiment of the present invention. Touch screen (1) includes an application interface (2) that cover whole screen, a textbox (3) of application interface (2).

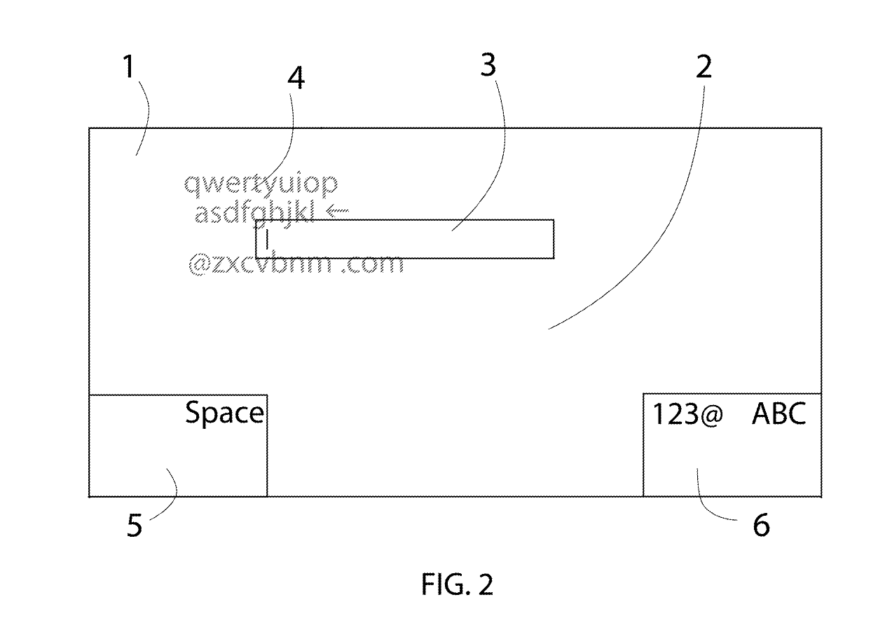

FIG. 2 shows the screen after a user touches the textbox (3). A virtual keyboard (4), a left lower corner (5), and a right lower corner (6) appear on top of the application interface (2). In this depicted example, the keyboard layout is similar to a QWERTY keyboard layout. Any other keyboard layouts, such as the Dvorak keyboard layout, may also be used within the scope of the present invention. The virtual keyboard (4) is transparent. Users enter symbols into the textbox (3) using the following method.

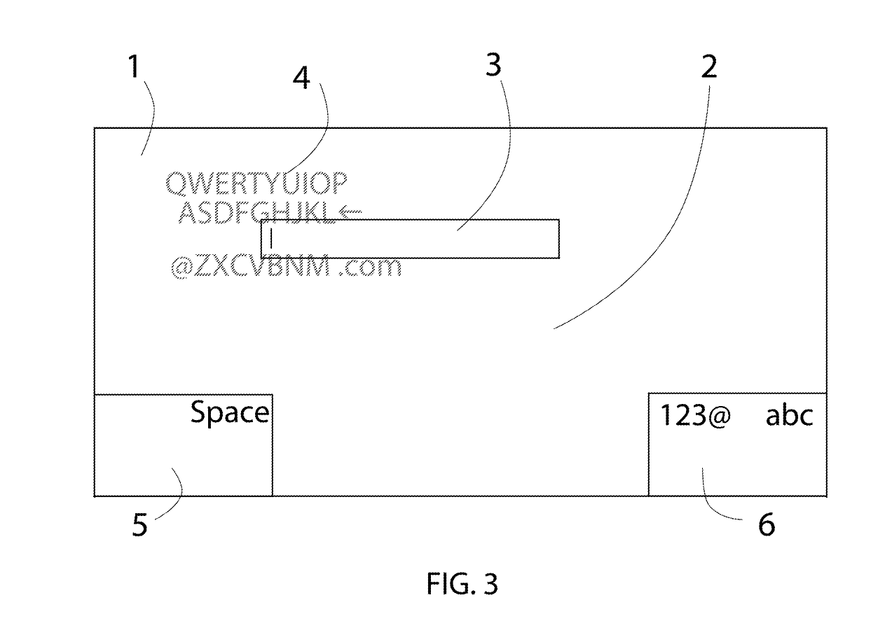

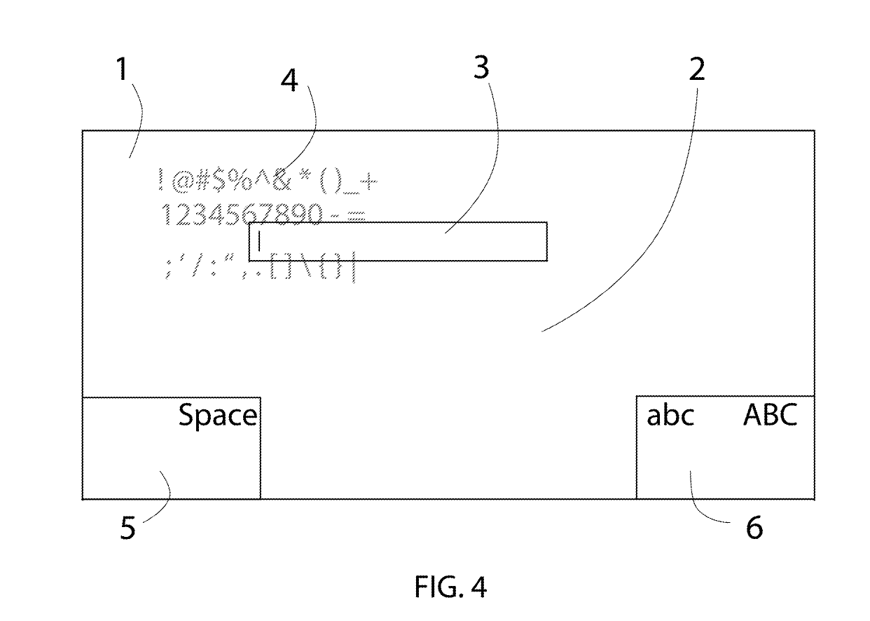

A user moves a symbol on the virtual keyboard (4) into the position of the text prompt by dragging one finger on the right lower corner (6) in an almost straight direction. When a symbol moves into the text prompt, that symbol appears at the text prompt. After the user sees the intended symbol appears at the text prompt, the user enters that symbol into the textbox (3) by either tapping any point except “Space” of the left lower corner (5) or moving the virtual keyboard (4) to almost opposite direction. After the user doing so, the intended symbol is entered into the textbox (3). Then, the text prompt moves to the next position and the virtual keyboard (4) moves automatically according to the new position of the text prompt. Then, new suggested words refresh in the lowest row of the virtual keyboard. The user enters the space by tapping the “Space” symbol in the left lower corner (5). When the user taps “ABC” symbol, the virtual keyboard (4) changes as illustrated in FIG. 3. When the user taps “123@” symbol, the virtual keyboard (4) changes as illustrated in FIG. 4. When the user taps “abc” symbol, the virtual keyboard (4) changes as illustrated in FIG. 2. The user can interact directly with the application under the virtual keyboard (4). When user touch any point of the application interface (2) except the left lower corner (5), the right lower corner (6), and the textbox (3), the virtual keyboard (4), the left lower corner (5), and the right lower corner (6) disappear as illustrated in FIG. 1.

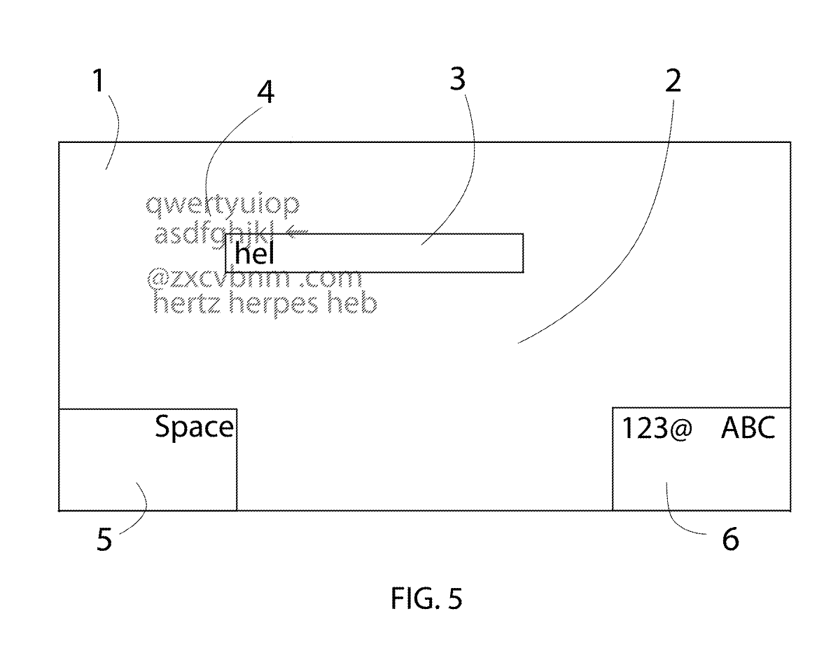

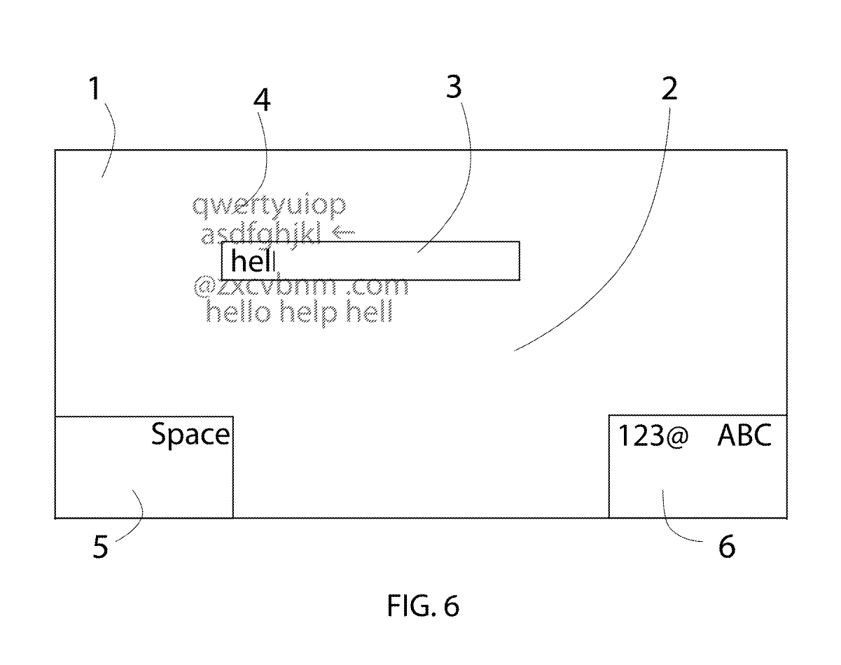

FIG. 5 and FIG. 6 illustrate how a user type first letter “1” of the word “hello”. The user moves the virtual keyboard by dragging one finger on the right lower corner (6) in an almost straight direction so that the symbol “1” on the keyboard moves into the text prompt. The character “1” appears next to “he” in the textbox (3). The result of this action is depicted in FIG. 5. Then, the user either taps any point except “Space” of the left lower corner (5) or drags the finger to an almost opposite direction so that the symbol “1” is entered into the textbox (3). Then the text prompt and the virtual keyboard (4) move automatically into a new position and the new suggested words appear at the lowest row. The result of this action is depicted in FIG. 6.

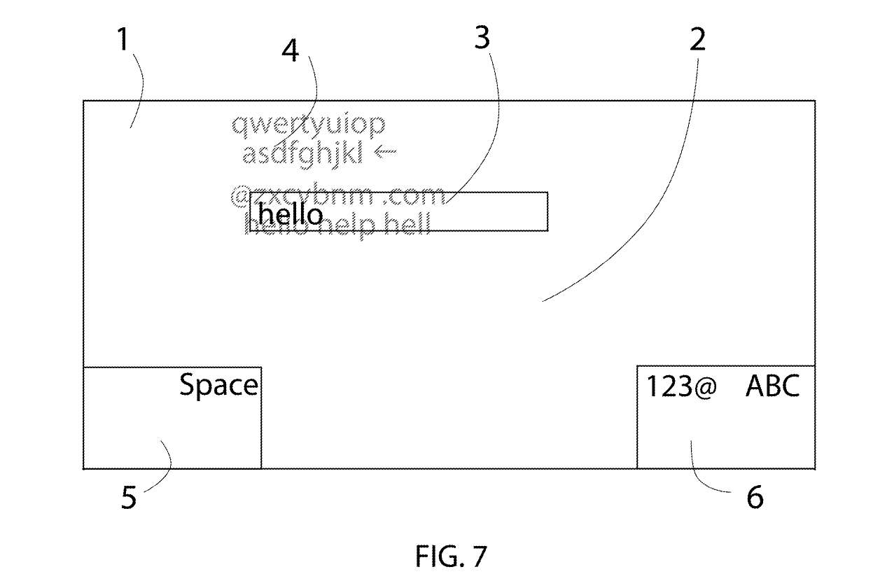

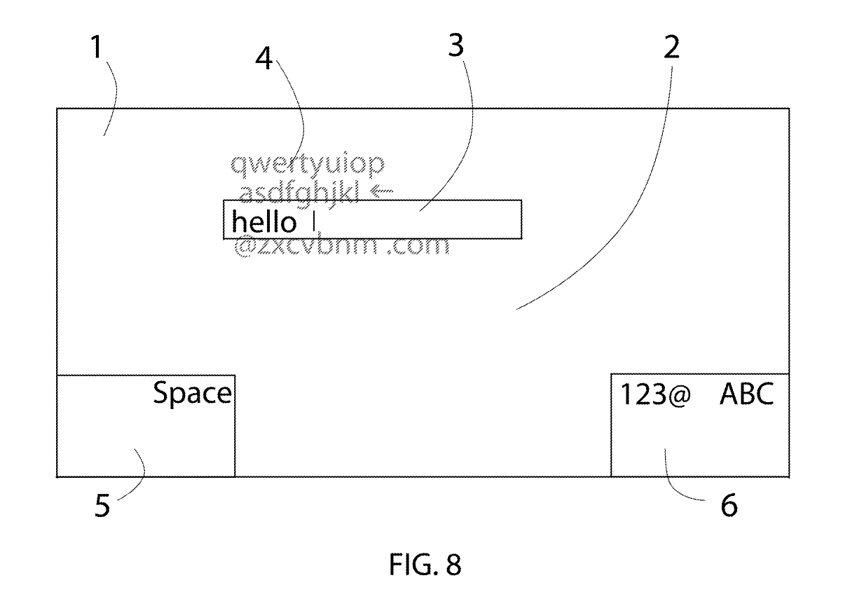

FIG. 7 and FIG. 8 illustrate how the user entered the word “hello” using the symbol for suggested word “hello”. The user moves the virtual keyboard by dragging one finger on the right lower corner (6) in an almost straight direction so that the symbol “hello” on the keyboard moves into the text prompt. The word “hello” appears in the textbox (3). The result of this action is depicted in FIG. 7. Then, the user either taps any point except “Space” of the left lower corner (5) or drags the finger to an almost opposite direction so that the word “hello” is entered into the textbox (3). Then the text prompt and the virtual keyboard (4) move automatically into a new position and the suggested words disappear at the lowest row. The result of this action is depicted in FIG. 8.

I claim:

1. A method for identifying user input includes a movement of a symbol of a virtual keyboard into a text prompt of a textbox in one direction and a movement of this symbol of the virtual keyboard out of the text prompt of the textbox in opposite direction or a tap on lower left corner of a touch screen.

2. A method for interacting with an application under a virtual keyboard includes making the virtual keyboard visually transparent; making the virtual keyboard interactively transparent; and allowing a user changes size of the virtual keyboard.

3. A method for moving a virtual keyboard includes dragging a finger on a lower corner of a touch screen.
